(19) United States
(12) Patent Application Publication
(10) Pub. No.: US 2023/0259840 A1
(43) Pub. Date: Aug. 17, 2023

(54) STATUS SENSING APPARATUS, METHOD, AND PROGRAM

(71) Applicant: NIPPON TELEGRAPH AND TELEPHONE CORPORATION, Tokyo (JP)

(72) Inventors: Taisuke WAKASUGI, Musashino-shi, Tokyo (JP); Tomoko SHIBATA, Musashino-shi, Tokyo (JP); Hiroshi YOSHIDA, Musashino-shi, Tokyo (JP); Rie SAKAI, Musashino-shi, Tokyo (JP)

(73) Assignee: NIPPON TELEGRAPH AND TELEPHONE CORPORATION, Tokyo (JP)

(21) Appl. No.: 18/012,283

(22) PCT Filed: Jun. 29, 2020
(86) PCT No.: PCT/JP2020/025531

§ 371 Date: Dec. 22, 2022

(51) Int. Cl. G06Q 10/0631

(52) U.S. Cl. CPC G06Q 10/063114

(57) ABSTRACT

A state detection device includes: an acquisition unit that acquires sensor values related to a center of gravity sway of a worker as time series data from a sensor which is disposed on a leg of equipment for work at height that the worker gets on and which outputs the sensor values; a calculation unit that calculates a feature of a center of gravity sway area and an evaluation value related to the center of gravity sway of the worker from the time series data; an abnormality determination unit that determines whether or not the sensor values are abnormal according to whether or not the feature of the center of gravity sway area satisfies an abnormality determination condition; and a determination unit that determines that the worker is in an unstable state if the sensor values are determined not to be abnormal and the evaluation value is equal to or greater than a threshold value.

### TECHNICAL FIELD

The present invention relates to a state detection device, method, and program for work at height.

### BACKGROUND ART

Accidents resulting in injury occurring during work at height, such as telecommunication construction, have become a problem, and falling accidents involving workers in particular occur a certain number of times every year. For this reason, there is a demand for a technology that identifies dangerous movements of a worker such as staggering or falling. For example, there is a technology in which a pressure sensor having a plurality of measurement points is disposed on an object on a flat plane, and a motion state of a worker is detected from pressure features when the worker performs movements on the object on the flat plane where the pressure sensor is disposed (for example, refer to Patent Literature 1).

### CITATION LIST

### Patent Literature

Patent Literature 1: Japanese Patent Laid-Open No. 2006-223651

### SUMMARY OF THE INVENTION

### Technical Problem

However, in the above example, there is a problem that the validity of the result of detecting the motion state of the worker cannot be guaranteed unless the validity of the output from the pressure sensor is also guaranteed.

The present invention has been made in view of the above circumstances, and an object thereof is to provide a device, a method, and a program that can detect abnormal output from a sensor.

### Means for Solving the Problem

A state detection device according to one aspect of the invention for achieving the above object includes: an acquisition unit that acquires sensor values related to a center of gravity sway of a worker as time series data from a sensor which is disposed on a leg of equipment for work at height that the worker gets on and which outputs the sensor values; a calculation unit that calculates a feature of a center of gravity sway area and an evaluation value related to the center of gravity sway of the worker from the time series data; an abnormality determination unit that determines whether or not the sensor values are abnormal according to whether or not the feature of the center of gravity sway area satisfies an abnormality determination condition; and a determination unit that determines that the worker is in an unstable state if the sensor values are determined not to be abnormal and the evaluation value is equal to or greater than a threshold value.

### Effects of the Invention

As such, according to the present invention, a technology for determining whether or not a sensor has abnormal output can be provided.

### BRIEF DESCRIPTION OF DRAWINGS

FIG. 1 is a block diagram illustrating a state detection system including a state detection device according to the present embodiment.

FIG. 2 is a diagram illustrating an example arrangement of a sensor unit attached to a tool for work at height.

FIG. 3 is a flowchart illustrating operations by the state detection device according to the present embodiment.

FIG. 4 is a diagram illustrating the center of gravity sway area and the maximum amplitude of the center of gravity sway area in the cases where the sensor output is normal and abnormal.

FIG. 5 is a diagram illustrating an example of management data stored in a work information management database according to the present embodiment.

FIG. 6 is a diagram illustrating an example of features of work information grouped by age and the center of gravity area stored in the work information management database.

FIG. 7 is a diagram illustrating an example of features of work information grouped by age and the center of gravity area for respective unit times stored in the work information management database.

FIG. 8 is a diagram illustrating an example of information which indicates that there is a strong possibility that the output from the sensors is abnormal, and which is outputted from an output unit 129 according to the present embodiment.

FIG. 9 is a diagram illustrating an example of a danger detection report outputted from an output unit.

### DESCRIPTION OF EMBODIMENTS

Hereinafter, a state detection device, method, and program according to an embodiment of the present disclosure will be described in detail and with reference to the drawings. Note that in the following embodiment, portions denoted by the same numerals are taken to perform similar operations, and a duplicate description will be omitted.

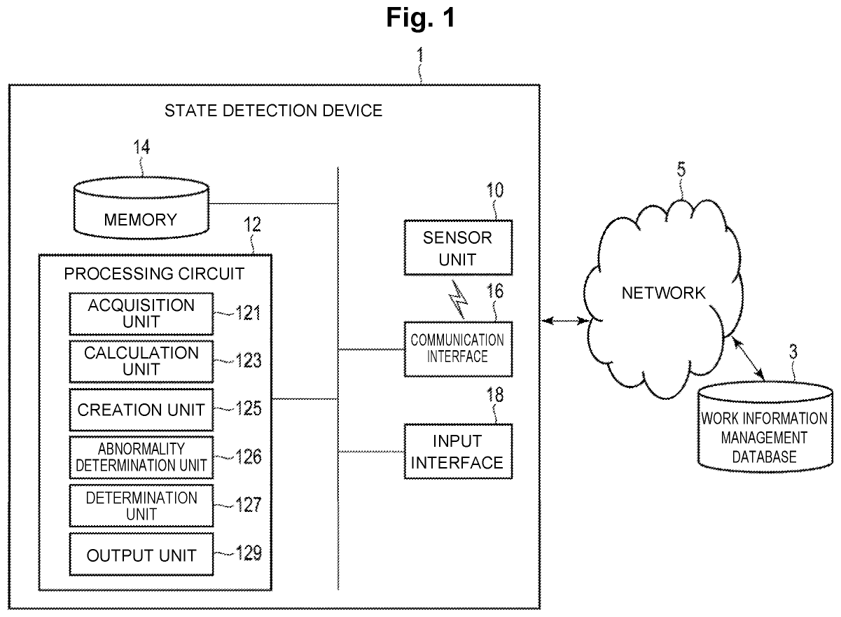

A state detection system including the state detection device according to the present embodiment will be described with reference to FIG. 1.

The state detection system according to the present embodiment includes a state detection device 1 and a work information management database 3.

The state detection device 1 and the work information management database 3 are connected in a wired or wireless way over a network 5. Note that although the example of FIG. 1 illustrates a single state detection device 1, a plurality of state detection devices 1 may also be connected to a single work information management database 3.

The state detection device 1 includes a sensor unit 10, a processing circuit 12, a memory 14, an input interface 18, and a communication interface 16. The processing circuit 12 includes an acquisition unit 121, a calculation unit 123, a creation unit 125, an abnormality determination unit 126, a determination unit 127, and an output unit 129. The processing circuit 12, the memory 14, the communication interface 16, and the input interface 18 are connected through a bus, for example. Note that the sensor unit 10 and the other components included in the state detection device 1 are connected in a wired or wireless way through the communication interface 16. Also, in FIG. 1, the sensor unit 10 is disposed inside the state detection device 1, but the sensor unit 10 may also be configured as a separate device from the state detection device 1. Furthermore, the sensor unit 10 may also transmit sensor values to the state detection device 1 in a wired or wireless way over the network 5.

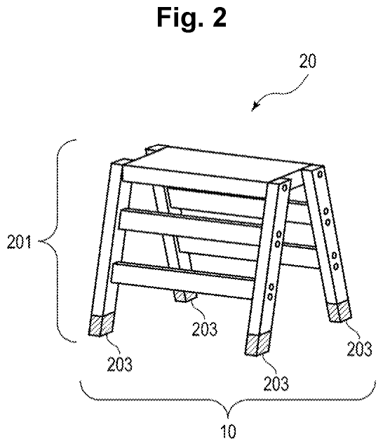

In the sensor unit 10, a plurality of sensors are disposed in a distributed way on the legs of a tool for work at height that a worker gets on, so that the worker's center of gravity can be calculated. In the description of the present embodiment, the tool for work at height is assumed to be a stepladder, but the tool for work at height may be any tool that a worker gets on when performing work at a height positioned above ground level, such as a ladder, a tripod, a workbench, or a scaffolding platform. The sensor unit 10 acquires sensor values that change in response to the movement of the worker's center of gravity. The sensors used as the sensor unit 10 are strain sensors capable of measuring pressure values, for example. Note that an example arrangement of the sensor unit 10 will be described later with reference to FIG. 2.

The acquisition unit 121 acquires time series data related to center of gravity sway of the worker from the sensor unit 10.

The calculation unit 123 calculates, from the time series data, a center of gravity sway area of the worker and the perimeter length of the center of gravity sway area. The calculation unit 123 additionally calculates features of the center of gravity sway area from the center of gravity sway area and the perimeter length of the center of gravity sway area. The features are the degree of circularity of the center of gravity sway area and the maximum amplitude of the center of gravity sway area, for example. The calculation unit 123 may also calculate the maximum value of the amplitude in each axial direction of the center of gravity path.

The creation unit 125 references the work information management database 3 to create average values of the features of the center of gravity sway area based on past work data about workers. The average values of the features of the center of gravity sway area are an average value of the degree of circularity of the center of gravity sway area (hereinafter referred to as the average degree of circularity) and an average value of the maximum amplitude of the center of gravity sway area (hereinafter referred to as the average maximum amplitude), for example. In addition, the creation unit 125 creates work information. The work information is data including a worker ID, a work start time, a work experience, and an evaluation value, for example. Note that the work experience is a value such as a number of times of work indicating how many times the worker has performed the work, or a cumulative work time.

The abnormality determination unit 126 determines whether or not the degree of circularity of the center of gravity sway area and the maximum amplitude of the center of gravity sway area calculated by the calculation unit 123 satisfy an abnormality determination condition. If the abnormality determination condition is satisfied, the abnormality determination unit 126 determines that the sensors have abnormal output.

In the case where the features of the center of gravity sway area satisfy the abnormality determination condition, the determination unit 127 determines whether the worker performing the work is in an unstable state. Specific examples of a worker in an unstable state include a state in which the worker has lost his or her balance and is staggering, and a state in which the worker is about to fall off the tool for work at height. The abnormality determination condition will be described later.

In the case where the abnormality determination unit 126 determines that the output from the sensors is abnormal, the output unit 129 outputs a sensor output abnormality report that includes information indicating that there is a strong possibility that the output from the sensors is abnormal, the worker ID, the features of the center of gravity sway area, and the center of gravity sway area of the worker. Also, in the case where the determination unit 127 has determined that the worker is in an unstable state, the output unit 129 outputs a danger detection report including the worker ID and an evaluation value of the sway of the worker's center of gravity on the basis of the work information data. The sensor output abnormality report and the danger detection report may be transmitted to the work information management database 3, and may also be displayed on a display viewable by the worker him- or herself, another worker, or an administrator.

Note that the processing circuit 12 is a processor such as a central processing unit (CPU) or an integrated circuit such as an application-specific integrated circuit (ASIC). The processing units described above (the acquisition unit 121, the calculation unit 123, the creation unit 125, the abnormality determination unit 126, the determination unit 127, and the output unit 129) may be achieved as functions of the processor or the integrated circuit by causing the processor or integrated circuit to execute a processing program.

The memory 14 stores data such as the sensor values, the features of the center of gravity sway area, and the worker ID. For example, the memory 14 may be a commonly used storage medium, such as a hard disk drive (HDD), a solid-state drive (SSD), or flash memory. Moreover, in a situation where the state detection device 1 is capable of transmitting and receiving data with respect to the work information management database 3 over the network 5, the state detection device 1 may transmit data (such as the sensor values, the features of the center of gravity sway area, the evaluation value, and the worker ID) to the work information management database 3 every time such data is acquired or generated, and the memory 14 does not have to store past data. In this case, the memory 14 may also be a temporary storage medium achieved with a volatile memory such as cache memory.

The communication interface 16 is an interface for communicating data with the work information management database 3. Furthermore, the communication interface 16 may also be an interface for communicating with an information processing device of another worker or an administrator. With this arrangement, the sensor output abnormality report or the danger detection report outputted from the output unit 129 can be displayed on a display provided in the information processing device of another worker or an administrator, as described above. Any commonly used communication interface may be used as the communication interface 16, and therefore a description is omitted here.

The input interface 18 is a mouse, a keyboard, a switch, a button, or a touch panel, for example, and receives input from the user of the state detection device 1. The state detection device may also include an output interface, namely a display that displays information and reports outputted from the output unit 129.

The work information management database 3 stores information transmitted from the state detection device 1, such as the work information, the worker ID, the work experience, a threshold value created by the creation unit 125, and the features of the center of gravity sway area. The work information management database 3 is assumed to be set up in a cloud server for example and to communicate with a plurality of state detection devices 1, but may also be stored in a dedicated server. Additionally, the work information management database 3 may also store features of the center of gravity sway area grouped by age or work experience as well as an average work experience and an average evaluation value according to age. The features of the center of gravity sway area grouped by age or work experience may be created on the basis of the features of the center of gravity sway area and the worker ID stored in the work information management database 3 and stored in the work information management database 3 by a processor in the cloud server that manages the work information management database 3 according to a program on the cloud server. Similarly, the work experience and average evaluation value grouped by age may also be created on the basis of the work information stored in the work information management database 3 and stored in the work information management database 3 by a processor in the cloud server according to a program on the cloud server.

Next, an example of the sensor unit 10 that is attached to a stepladder treated as the tool for work at height that a worker gets on will be described with reference to FIG. 2.

As illustrated in FIG. 2, the sensor unit 10 includes sensors 203 disposed on each leg 201 of a stepladder 20 that a worker gets on. The sensors 203 are assumed to be attached to the ends of the legs 201 of the stepladder 20, for example. Ordinarily, anti-slip grips of a rubber material or the like are provided on the ends on the legs 201. Consequently, the sensors 203 may be disposed between the anti-slip grips and the ends of the legs 201, or the sensors 203 may be embedded into the anti-slip grips themselves. Alternatively, a member having an anti-slip function that includes the sensor unit 10 may be provided over the anti-slip grips on the ends of the legs 201.

The sensors 203 are assumed to acquire pressure values as the sensor values, but other sensed information, such as the time, altitude, temperature, or a magnetic field may also be acquired as sensor values. In the example of FIG. 2, four sensors 203 are disposed respectively on the legs 201, thereby enabling the state detection device 1 to acquire the pressure when a worker gets on the stepladder 20 from each of the sensors 203 as sensor values. When a worker gets on the stepladder 20, the pressure imparted to the sensors 203 varies, which enables the state detection device 1 to detect that the worker has gotten on the stepladder 20. Furthermore, by continuing to acquire sensor values from the positions of the four sensors 203 at fixed intervals, the state detection device 1 can calculate amplitudes in the worker's center of gravity from time series data of the sensor values.

Note that it is sufficient if the sensors 203 are respectively attached to the ends of the legs of a tool for work at height, and in the case of a stepladder, it is sufficient if four sensors 203 are provided. In the case of a ladder, it is sufficient if the sensors 203 are provided on the legs in contact with the ground and the legs in contact with the object on which the ladder leans, for a total of four sensors 203.

The sensor unit 10 also includes a tag recognition unit that senses an ID recognition tag carried by the worker. The ID recognition tag contains the worker ID that uniquely identifies the worker. The sensor unit 10 recognizes the ID recognition tag of the worker who is about to get on the stepladder 20 to perform work, and acquires the worker ID of the worker on the stepladder 20 and the time at which the worker got on the stepladder. The recognition of the ID tag by the sensor unit 10 may be configured such that recognition is achieved by having the worker bring the ID recognition tag in close proximity or contact with the sensor unit 10, or such that the sensor unit 10 can recognize an ID recognition tag existing within a certain range from the sensor unit 10, for example.

Note that instead of identifying the worker ID through the ID recognition tag, the worker ID of the worker on the stepladder 20 may also be identified by having the worker perform the work of inputting his or her own worker ID into the input interface 18 of the state detection device 1.

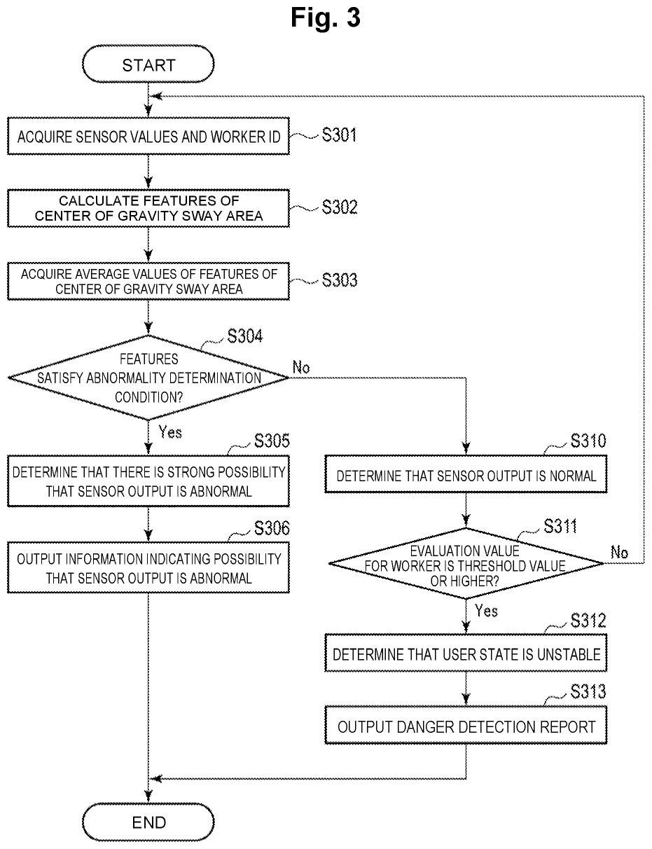

Next, operations by the state detection device 1 according to the present embodiment will be described with reference to the flowchart in FIG. 3. Note that herein, the equipment for work at height is assumed to be a stepladder.

In step S301, the acquisition unit 121 acquires the sensor values, the sampling time, and the worker ID from the sensor unit 10. Note that the acquisition unit 121 may also acquire the time at which the worker got on the stepladder.

In step S302, the calculation unit 123 calculates the current center-of-gravity position of the worker from the sensor values. The center-of-gravity position is stored together with the sampling time in the memory 14. Here, although not illustrated in FIG. 3, steps S301 and S302 are repeated for the duration of a predetermined time from when the worker gets on the stepladder and starts the work. Note that the predetermined time is taken to enough time to calculate the center of gravity sway area from the path of the center-of-gravity position. Additionally, the calculation unit 123 calculates the path of the center-of-gravity position from the worker's center-of-gravity positions and the sampling times stored up to now in the memory 14. From the calculated path of the center-of-gravity position, the calculation unit 123 calculates the center of gravity sway area and the perimeter length of the center of gravity sway area. The calculation unit 123 additionally calculates features of the center of gravity sway area from the center of gravity sway area and the perimeter length of the center of gravity sway area. Here, the features of the center of gravity sway area are the degree of circularity and the maximum amplitude of the center of gravity sway area. Note that the center of gravity sway area may be calculated according to typical calculation methods such as the peripheral area, the square area, or the effective area, and therefore a detailed description is omitted here. For the perimeter length of the center of gravity sway area, it is sufficient to use typical calculation methods such as geometry or image analysis, and therefore a detailed description is omitted here. The degree of circularity of the center of gravity sway area is calculated by the calculation unit 123 as 4πS/L², where S is the center of gravity sway area and L is the perimeter length of the center of gravity sway area. For the maximum amplitude of the center of gravity sway area, it is sufficient to use typical calculation methods such as geometry or image analysis from the center of gravity sway area and the perimeter length of the center of gravity sway area, and therefore a detailed description is omitted here.

If the sensor values from the legs of the stepladder 20 are equal, the worker's center of gravity may be assumed to be in the center of a planar region prescribed by the arrangement of the four sensors 203 (for example, the center of a work region for the worker prescribed by the four legs 201 of the stepladder 20). Accordingly, by comparing the amplitudes in each of the sensor values, it is possible to calculate where the worker's center of gravity exists within the planar region. Note that in the case of a ladder or the like, some amount of pre-existing bias in the sensor values is conceivable, but it is sufficient to treat the values from the sensors 203 before the worker gets on the ladder as an initial state, and calculate the worker's center of gravity according to the amplitudes in the sensor values from the initial state.

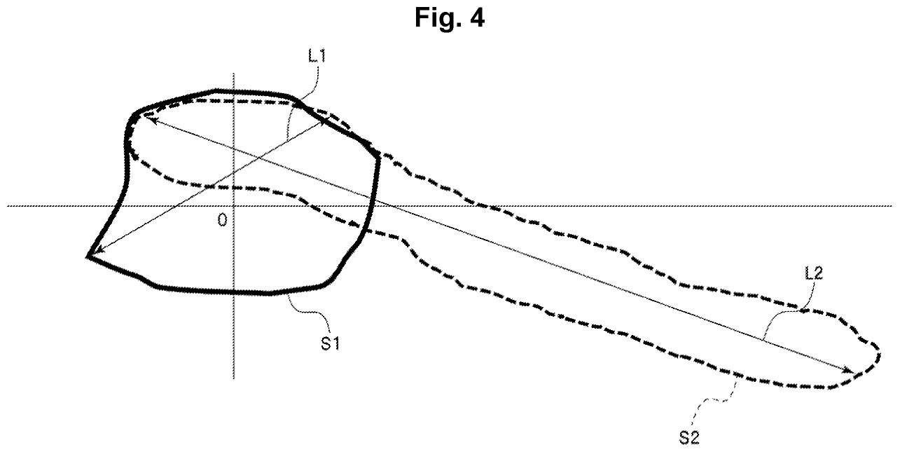

FIG. 4 is a diagram illustrating the center of gravity sway area S1 and the maximum amplitude L1 of the center of gravity sway area S1 in the case where the sensor output is normal, and the center of gravity sway area S2 and the maximum amplitude L2 of the center of gravity sway area S2 in the case where the sensor output is abnormal. The shape of the center of gravity sway area S2 in the case where the sensor output is abnormal is closer to an ellipse compared to the shape of the center of gravity sway area S1 in the case where the sensor output is normal. For this reason, the degree of circularity of the center of gravity sway area S2 is smaller than the degree of circularity of the center of gravity sway area S1. Furthermore, the maximum amplitude L2 of the center of gravity sway area S2 is larger than the maximum amplitude L1 of the center of gravity sway area S1. The above demonstrates that in a state in which there is a strong possibility of abnormal output from the sensors, the degree of circularity of the center of gravity sway area is smaller than the degree of circularity of the normal center of gravity sway area, and the maximum amplitude is larger than the maximum amplitude of the normal center of gravity sway area.

In step S303, the creation unit 125 references the work information management database 3 to create the average degree of circularity of the center of gravity sway area and the average maximum amplitude of the center of gravity sway area. Specifically, the worker ID acquired in step S301 is treated as a key to acquire, from the work information management database 3, the features of the center of gravity sway area for work performed in the past by the worker who is currently working. The creation unit 125 may create the average degree of circularity and the average maximum amplitude from the features. Note that the creation unit 125 may also use the worker ID as a key to acquire the age and work experience of the worker who is currently working stored in the work information management database 3, and also acquire the features of the center of gravity sway area of workers similar in age and work experience to the current worker from the work information management database 3. Thereafter, the creation unit 125 may create the average degree of circularity and the average maximum amplitude from the features. For example, in the case where the age of the worker stored in the work information management database 3 is 34 years and the work experience with the stepladder is 7 times, the creation unit 125 may acquire the features of the center of gravity sway area of workers in their early 30s who have worked on the stepladder from 5 to 10 times which are stored in the work information management database 3, and create the average degree of circularity and the average maximum amplitude from the features. The above method may also be used in cases such as when a record of the worker performing previous work on the stepladder does not exist in the work information management database 3. Note that the above is merely an example, and obviously the creation unit 125 may create the average circularity and the average maximum amplitude by acquiring the features of the center of gravity sway area within a freely chosen age range and a range of similar work experience stored in the work information management database 3.

In step S304, the abnormality determination unit 126 determines whether or not the features of the center of gravity sway area satisfy the abnormality determination condition. Here, the abnormality determination condition is the case where the degree of circularity calculated by the calculation unit 123 is equal to or less than the average degree of circularity created by the creation unit 125 and the maximum amplitude of the center of gravity sway area calculated by the calculation unit 123 is equal to or greater than the average maximum amplitude created by the creation unit 125. If the abnormality determination unit 126 determines that the abnormality determination condition is satisfied, or in other words, in the case where the degree of circularity is equal to or less than the average degree of circularity and the maximum amplitude of the center of gravity sway area is equal to or greater than the average maximum amplitude, the flow proceeds to step S305. Otherwise, the flow proceeds to step S310.

In other words, in the case where the abnormality determination unit 126 determines that the abnormality determination condition is satisfied in step S304, the abnormality determination unit 126 determines that there is a strong possibility that the sensor output is abnormal in step S305.

In step S306, the output unit 129 outputs a sensor output abnormality report that includes information indicating that there is a strong possibility that the sensor output is abnormal.

On the other hand, in the case where the abnormality determination unit 126 determines that the abnormality determination condition is not satisfied in step S304, the abnormality determination unit 126 determines that the sensor output is normal in step S310.

Since the sensor output is normal, the worker's center-of-gravity position is understood to be in a normal position. Accordingly, in step S311, to determine whether or not the worker is in an unstable state or not, the determination unit 127 determines whether or not the evaluation value of the worker is a threshold value or higher. The evaluation value is the received sway area calculated by the calculation unit 123, for example, and the threshold value is the average center of gravity sway area for the age of the worker stored in the work information management database 3, for example. If the evaluation value is the threshold value or higher, the flow proceeds to step S312, whereas if the evaluation value is lower than the threshold value, the flow returns to step S301 and a similar process is repeated. Note that the evaluation value and the threshold value are merely an example, and obviously any evaluation value and threshold value created from the center of gravity sway and the work information may be adopted.

Note that by repeating the process of steps S301 and S302, sensor values are newly acquired and added to the data about the center-of-gravity position stored in the memory 14 as new data about the center-of-gravity position. Additionally, the creation unit 125 calculates the path of the center of gravity on the basis of the time series data successively updated in this way, and the center of gravity sway area can be calculated. Note that the process of acquiring the worker ID in step S301 and the process of creating the average degree of circularity, the average maximum amplitude, and the average values of the center of gravity sway area grouped by age in step S303 only need to be performed once. For this reason, the above processes may be omitted when the flow is repeated.

In the case where the determination unit 127 determines that the evaluation value of the worker is the threshold value or higher in step S311, the determination unit 127 determines that the worker performing work is in an unstable state in step S312.

In step S313, the output unit 129 outputs a danger detection report including a graph of the center of gravity sway area that was determined to be unstable, on the basis of the work information created in step S303.

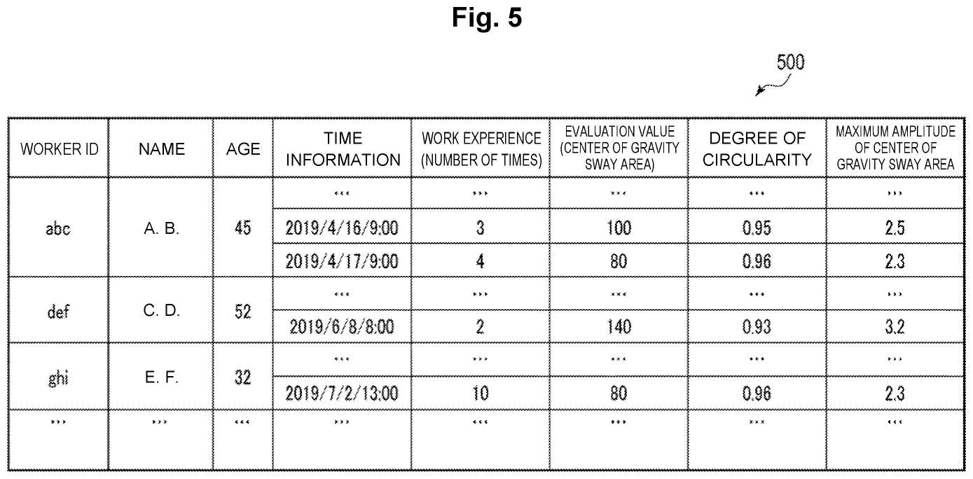

Next, an example of the management data stored in the work information management database 3 is illustrated in FIG. 5.

The worker ID, name, age, time information work experience, evaluation value, and the features of the center of gravity sway area are associated with each other and stored in a management data table 500 as the management data. Note that in FIG. 5, the degree of circularity and the maximum amplitude of the center of gravity sway area are stored as the features of the center of gravity sway area.

The time information is the work start time of the worker. Note that the time when the worker got off the tool for work at height may be treated as a work end time, the difference between the work end time and the work start time may be taken to calculate a work time, and the work time may be stored as the time information.

In the present embodiment, the work experience is assumed to be a number of times indicating how many times the worker has performed the work, but the work experience may also be a cumulative work time or the number of years of experience, and may be any value that can express the worker's experience in relation to the work.

When work information and features of the center of gravity sway area transmitted from the state detection device 1 are received, and the work start time included in the work information is different from the work start time of the same worker ID already stored in the management data table 500, items for the time information, work experience, evaluation value, degree of circularity, and maximum amplitude of the center of gravity sway area are added as a new entry for the same worker ID in the work information management database 3 illustrated in FIG. 5. At this time, the value of the previously stored work experience is incremented by 1 and stored as the work experience.

In the example of FIG. 5, an entry containing the time information “2019/4/16/9:00”, the work experience (number of times) “3”, the evaluation value (center of gravity sway area) “100”, the degree of circularity “0.95”, and the maximum amplitude of the center of gravity sway area “2.5”, and an entry containing the time information “2019/4/17/9:00”, the work experience (number of times) “4”, the evaluation value (center of gravity sway area) “80”, the degree of circularity “0.96”, and the maximum amplitude of the center of gravity sway area “2.3” are each stored in association with a person having the worker ID “abc”, the name “A. B.”, and the age “45”.

Note that the most recent work data may also be stored with respect to the worker ID without leaving a history of the work experience up to now. In other words, in the example of FIG. 5, only the entry related to the work experience “4” may be stored. In this case, the past time information, work experience, center of gravity sway area, degree of circularity, and maximum amplitude of the center of gravity sway area may be stored as separate items in association with the worker ID.

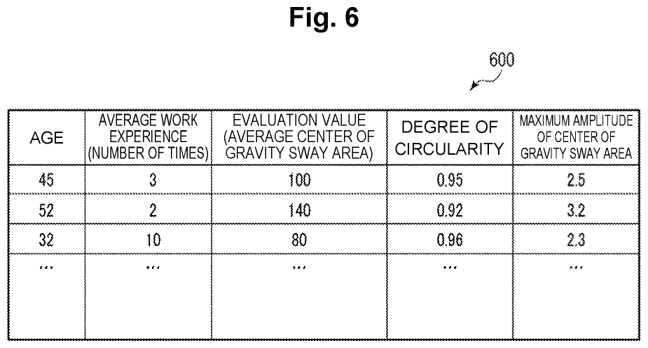

Next, an example of work information grouped by age and stored in the work information management database 3 will be described with reference to FIG. 6.

In FIG. 6, the age, average work experience, evaluation value (average center of gravity sway area), degree of circularity, and maximum amplitude in the center of gravity sway area are respectively associated with each other and stored as the work information grouped by age in a work information grouped by age table 600.

The age is not limited to groups of one year each, such as 20 years old or 32 years old, and may also be age groups with a certain range, such as “30 to 35 years old”. The average work experience and evaluation value (average center of gravity sway area) grouped by age may be calculated by accumulating work data as illustrated in FIG. 5 obtained from a plurality of state detection devices 1, and having a person such as an administrator of the cloud server or a program on the cloud server perform analysis such as taking the average by age.

In the example of FIG. 6, the creation unit 125 may acquire the age of the worker and the features of the center of gravity sway area, namely the degree of circularity and the maximum amplitude of the center of gravity sway area, of workers with similar work experience from the work information management database 3 as described above with reference to FIG. 3, and respectively create the average degree of circularity and the average maximum amplitude from the acquired degrees of circularity and maximum amplitudes of the center of gravity.

Note that there is a possibility that the shape of the center of gravity sway area may change due to fatigue from working for long periods of time. Consequently, in this case, the creation unit 125 creates an average center of gravity sway area or a maximum center of gravity sway area for the current worker per unit time, and stores the created information in the work information management database 3. Thereafter, the determination unit 127 may change the average center of gravity sway area or the maximum center of gravity sway area for the current worker to the average center of gravity sway area or the maximum center of gravity sway area for the corresponding unit time according to the length of the work time by the worker, and determine whether or not the worker is in an unstable state. Likewise, the calculation unit 123 also creates the degree of circularity and the maximum amplitude of the center of gravity sway area per unit time, and stores the created information in the work information management database 3.

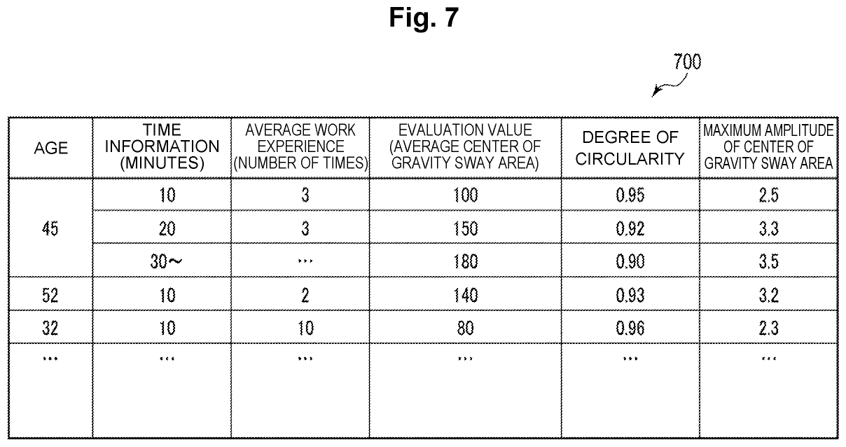

An example of the work information grouped by age, the degree of circularity, and the maximum amplitude of the center of gravity sway area per unit time that are stored in the work information management database 3 will be described with reference to FIG. 7.

Compared to the work information by age table 600 illustrated in FIG. 6, the work information grouped by age table 700 illustrated in FIG. 7 differs by including entries for the time information and the evaluation value (average center of gravity sway area) per unit time. Here, 10 minutes is assumed as the unit time.

For example, during the work from the start up to 10 minutes, the determination unit 127 may treat an average center of gravity sway area of “100” as a basis for determining the state of the worker according to whether or not the currently measured center of gravity sway area is “100” or greater.

Next, during the work in the next unit time from 10 minutes to 20 minutes since the start, there is a possibility that some slight disturbances in the worker's center of gravity may occur due to fatigue, and therefore the average center of gravity sway area is increased a little. The determination unit 127 may treat an average center of gravity sway area of “150” as a basis for determining the state of the worker according to whether or not the currently measured center of gravity sway area is “150” or greater. This arrangement makes it possible to raise the accuracy of detecting instability in the state of the worker.

However, it is necessary to prescribe a value above which additional swaying is dangerous as an upper limit on the average center of gravity sway area irrespectively of the work time, and therefore if the work time is a certain time or longer, the average center of gravity sway area is set to a fixed value regardless of the unit time. For example, the average center of gravity sway area may be set to “180” in cases where the work time is 30 minutes or longer. Thus, for work that is the fixed work time or longer, the determination unit 127 may determine the state of the worker according to whether or not the currently measured center of gravity sway area is “180” or greater.

Additionally, during work from the start up to 10 minutes, for example, the creation unit 125 may also acquire the age of the worker and the features of the center of gravity sway area of workers with similar work experience from the work information management database 3, and create an average degree of circularity and an average maximum amplitude. Thereafter, the abnormality determination unit 126 can determine whether or not the sensors have abnormal output by comparing the average degree of circularity and the average degree of circularity to the center of gravity sway area and the maximum amplitude of the center of gravity sway area calculated by the calculation unit 123. The creation unit 125 may also create an average degree of circularity and an average maximum amplitude similarly to the above for work from 10 minutes up to 20 minutes since the start and work with a work time of 30 minutes or longer since the start.

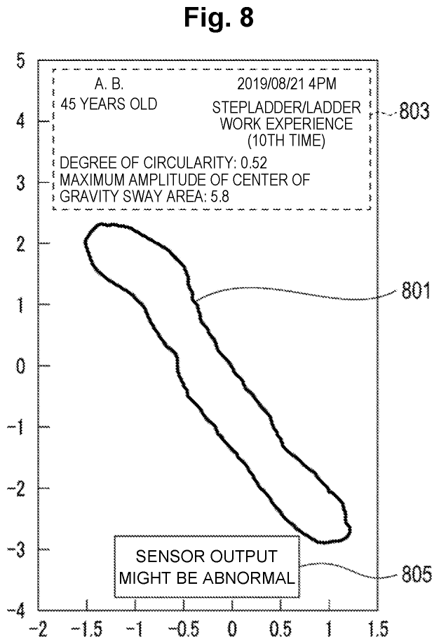

Next, FIG. 8 illustrates an example of a sensor output abnormality report outputted from the output unit 129 and indicating that there is a strong possibility that the sensors have abnormal output.

FIG. 8 illustrates an example in which a graph 801 related to the center of gravity sway area is displayed as the information, and work data 803 and a possible sensor output abnormality message 805 are overlaid onto the graph 801 related to the center of gravity sway area. The possible sensor output abnormality message 805 may be expressed in any way enabling the user to understand that there is a possibility of abnormal sensor output. Specifically, the name “A. B.”, the age “45”, the start time “2019/08/21 4 PM”, the work experience “stepladder/ladder (10th time)”, the degree of circularity “0.52”, and the maximum amplitude “5.8” of the center of gravity sway area are displayed as the work data above the graph 801 related to the center of gravity sway area. In addition, the possible sensor output abnormality message 805, such as “The sensor output may be abnormal”, for example, is displayed below the graph 801 related to the center of gravity sway area.

By looking at the information illustrated in FIG. 8, the current worker, another worker, or an administrator can grasp the possibility that one of the sensors 203 of the sensor unit 10 has abnormal output. Furthermore, the worker or the like can remove the cause of the abnormal output from the sensor 203.

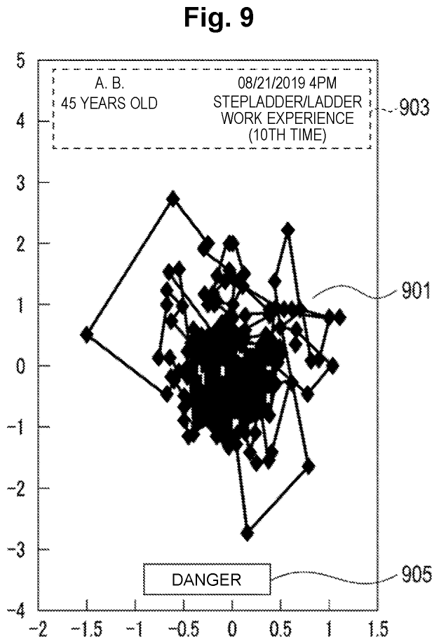

Next, an example of a danger detection report outputted from the output unit 129 is illustrated in FIG. 9.

FIG. 9 illustrates an example in which a graph 901 related to the path of the center of gravity sway is displayed as the danger detection report, and work data 903 and an unstable state detection message 905 are overlaid onto the graph 901 related to the path of the center of gravity sway. The unstable state detection message 905 may be expressed in any way enable the user to understand that the worker is in an unstable state and is also in danger. Specifically, the name “A. B.”, the age “45”, the start time “2019/08/21 4 PM”, and the work experience “stepladder/ladder (10th time)” are displayed as the work data above the graph 901 related to the path of the center of gravity sway. In addition, the unstable state detection message 905, such as “DANGER” for example, is displayed below the graph 901 related to the path of the center of gravity sway.

By looking at the danger detection report illustrated in FIG. 9, the current worker can objectively grasp the instability that he or she did not recognize from his or her own sense of balance. Furthermore, by looking at the danger detection report, another worker or an administrator can grasp signs such as staggering more than usual, and perform danger prediction that grasps dangerous signs in advance.

According to the present embodiment indicated above, sensors are attached to the legs of a tool for work at height, such as a stepladder or a ladder, and features of the center of gravity sway area, such as the degree of circularity and the maximum amplitude of the center of gravity sway area, can be used to determine whether or not the sensor output is abnormal.

Furthermore, by informing the worker or nearby people that the sensor output is abnormal, the worker, another worker, or an administrator is able to notice the sensor abnormality. With this arrangement, the true state of the worker can be grasped correctly, thereby making it possible to avoid a fatal false determination during safety monitoring, namely recognizing the state as being a safe state even though the state is actually a dangerous state.

In addition, even in the case where a worker performs work for the first time, it is possible to determine whether or not the sensor output is abnormal by calculating averages of the features of the center of gravity sway area from work performed in the past by workers of a similar age or workers who have performed the work a similar number of times.

Furthermore, because the validity of the output from the sensors is guaranteed, the validity of the result of detecting the motion state of the worker can also be guaranteed. As a result, the worker can be monitored without missing dangerous signs, and therefore the state of the worker can be detected easily while also ensuring the safety of the worker.

Note that the instructions indicating in the processing sequence illustrated in the embodiment described above may be executed by a computer on the basis of a software program.

Moreover, the features of the center of gravity sway area are described as the degree of circularity of the center of gravity sway area and the maximum amplitude of the center of gravity sway area, and the average values of the features of the center of gravity sway area are described as the average degree of circularity, which is an average value of the degree of circularity of the center of gravity sway area, and the maximum amplitude, which is an average value of the degree of circularity of the center of gravity sway area. However, other values may also be used as the features of the center of gravity sway area and their average values.

Also, the sensor output abnormality report may also not include the specific features of the center of gravity sway area or the center of gravity sway area of the worker, but only output information indicating that there is a possibility that the sensor output is abnormal and the worker ID, or in other words, simply output that there is an abnormality.

Also, the output of the sensor output abnormality report and the danger detection report may not only be a display output to a display, but also output a warning sound or a warning message from a speaker at the same time.

Additionally, the sensor unit 10 is configured such that a plurality of sensors are disposed in a distributed way on the legs of the tool for work at height that a worker gets on, so that the worker's center of gravity can be calculated. However, in the case of using a sensor that can calculate the worker's center of gravity by itself, the sensor unit 10 may include only one such sensor.

In short, the present invention is not solely limited to the above embodiment, and may be realized by modifying structural elements in the implementation stage within a scope that does not depart from the gist of the present invention. In addition, various inventions can be formed by an appropriate combination of a plurality of the structural elements disclosed in the above embodiment. For example, some structural elements may be removed from the structural elements illustrated in the embodiments. Furthermore, structural elements from different embodiments may also be combined appropriately.

### REFERENCE SIGNS LIST

1 State detection device
3 Work information management database
5 Network
10 Sensor unit
12 Processing circuit
14 Memory
16 Communication interface
18 Input interface
121 Acquisition unit
123 Calculation unit
125 Creation unit
126 Abnormality determination unit
127 Determination unit
129 Output unit
20 Stepladder
201 Leg
203 Sensor
500 Management data table
600 Work information grouped by age table
700 Work information grouped by age table
801 Graph related to center of gravity sway area
803, 903 Work data
805 Possible sensor output abnormality message
901 Graph related to path of center of gravity sway
905 Unstable state detection message

1. A state detection device comprising:
a processor; and
a storage medium having computer program instructions stored thereon, when executed by the processor, perform to:
acquires sensor values related to a center of gravity sway of a worker as time series data from a sensor which is disposed on a leg of equipment for work at height that the worker gets on and which outputs the sensor values;
calculates a feature of a center of gravity sway area and an evaluation value related to the center of gravity sway of the worker from the time series data;
determines whether or not the sensor values are abnormal according to whether or not the feature of the center of gravity sway area satisfies an abnormality determination condition; and
determines that the worker is in an unstable state if the sensor values are determined not to be abnormal and the evaluation value is equal to or greater than a threshold value.

2. The state detection device according to claim 1, wherein the computer program instructions further perform to calculates the center of gravity sway area and a perimeter length of the center of gravity sway area on a basis of the time series data, and calculates a degree of circularity and a maximum amplitude of the center of gravity sway area on a basis of the center of gravity sway area and the perimeter length of the center of gravity sway area as the feature.

3. The state detection device according to claim 1 wherein the computer program instructions further perform to creates an average value of the degree of circularity of the center of gravity sway area and an average value of the maximum amplitude of the center of gravity sway area from the feature of the center of gravity sway area of work performed by the worker in the past.

4. The state detection device according to claim 1 wherein the computer program instructions further perform to creates an average value of the degree of circularity of the center of gravity sway area and an average value of the maximum amplitude of the center of gravity sway area from the feature of the center of gravity sway area of a worker who is different from the worker and who corresponds to an age or a work experience of the worker.

5. The state detection device according to claim 3, wherein the abnormality determination condition is that the degree of circularity of the center of gravity sway area is less than or equal to the average value of the degree of circularity of the center of gravity sway area, and the maximum amplitude of the center of gravity sway area is equal to or greater than the average value of the maximum amplitude of the center of gravity sway area.

6. The state detection device according to claim 1, further comprising:
an output unit that outputs a notification indicating that the output from the sensor is abnormal in a case where the abnormality determination unit has determined that the sensor values are abnormal.

7. A state detection method for a state detection device which is provided with a processor and which detects a state of a worker who gets on equipment for work at height, the state detection method comprising:
acquiring, by the processor, sensor values related to a center of gravity sway of the worker as time series data from a sensor which is disposed on a leg of the equipment for work at height and which outputs the sensor values;
calculating, by the processor, a feature of a center of gravity sway area and an evaluation value related to the center of gravity sway area of the worker from the time series data;
determining, by the processor, whether or not the sensor values are abnormal according to whether or not the feature of the center of gravity sway area satisfies an abnormality determination condition; and
determining, by the processor, that the worker is in an unstable state if the sensor values are determined not to be abnormal and the evaluation value is equal to or greater than a threshold value.

8. A non-transitory computer-readable medium having computer-executable instructions that, upon execution of the instructions by a processor of a computer, cause the computer to function as the state detection device according to claim 1.
